(19) United States
(12) Patent Application Publication
(10) Pub. No.: US 2019/0310714 A1
(43) Pub. Date: Oct. 10, 2019

(54) MOTION EVALUATION SYSTEM, METHOD THEREOF AND COMPUTER-READABLE RECORDING MEDIUM

(71) Applicants: Ying-Chi Huang, Taipei City (TW); Miao-Ju Hsu, Taipei City (TW); Chih-Yuan Chi, Taipei City (TW); Chin-Liang Ko, Taipei City (TW); Nien-Lun Chen, Taipei City (TW); Huang-Chih Chen, Taipei City (TW); Fu-Ruei Li, Taipei City (TW); Wei-Hsi Chen, Taipei City (TW); Chia-Hung Ou, Taipei City (TW)

(72) Inventors: Ying-Chi Huang, Taipei City (TW); Miao-Ju Hsu, Taipei City (TW); Chih-Yuan Chi, Taipei City (TW); Chin-Liang Ko, Taipei City (TW); Nien-Lun Chen, Taipei City (TW); Huang-Chih Chen, Taipei City (TW); Fu-Ruei Li, Taipei City (TW); Wei-Hsi Chen, Taipei City (TW); Chia-Hung Ou, Taipei City (TW)

(73) Assignee: COMPAL ELECTRONICS, INC., Taipei City (TW)

(21) Appl. No.: 16/379,799

(22) Filed: Apr. 10, 2019

Related U.S. Application Data
(60) Provisional application No. 62/655,240, filed on Apr. 10, 2018.

(51) Int. Cl. G06F 3/01; G06F 9/54; G06F 17/50

(52) U.S. Cl. CPC G06F 3/017; G06F 17/5009; G06F 3/011; G06F 9/542

(57) ABSTRACT

A motion evaluation system, a method thereof and a computer-readable recording medium are provided. The motion evaluation system includes at least one sensor and a processor. The sensor generates sensing data for a motion posture. The processor obtains the motion posture of the sensor, determines a continued time accumulated when the motion posture conforms to a correct posture, and sends a notification message according to the continued time. The correct posture is related to an angle at which a portion under test inclined to a reference object. Accordingly, the rehabilitation can be performed anytime and anywhere, and it is easier for tracking the rehabilitation situation.

### CROSS REFERENCE TO RELATED APPLICATION

This application claims the priority benefit of U.S. provisional application Ser. No. 62/655,240, filed on Apr. 10, 2018. The entirety of the above-mentioned patent application is hereby incorporated by reference herein and made a part of specification.

### BACKGROUND

### Technical Field

The disclosure relates to a behavior monitoring technology, and more particularly to a motion evaluation system, a method thereof, and a computer-readable recording medium.

### Description of Related Art

Modern medical care has developed specialized subjects for rehabilitation medicine for physical disability caused by special diseases, surgeries, or physical injuries. For dealing with different disability situations, specific body portions can be used to gradually improve functions such as limb swing amplitude, balance, stability, maintenance, or speed of execution. In this way, normal functions may be restored or may be gradually achieved, and that the quality of life of patients is further enhanced. Nevertheless, most of the existing rehabilitation medical procedures are assisted by rehabilitation therapists who face the patients in person. It is thus troublesome for patients with limited mobility.

### SUMMARY

Accordingly, the disclosure provides a motion evaluation system and a method thereof and a computer-readable recording medium configured to evaluate a rehabilitation progress of a user through a sensor, so that the user may perform rehabilitation at home.

A motion evaluation system in an embodiment of the disclosure includes at least one sensor and a processor. The sensor generates sensing data for a motion posture. The processor obtains the motion posture of the sensor, determines a continued time accumulated when the motion posture conforms to a correct posture according to the sensing data, and sends a notification message according to the continued time. The correct posture is related to an angle at which a portion under test inclined to a reference object.

In an embodiment of the disclosure, the processor determines whether the continued time when the motion posture conforms to the correct posture reaches a continued threshold value. In response to that the continued time reaches the continued threshold value, the processor generates a notification message related to posture fulfillment.

In an embodiment of the disclosure, in response to that the continued time does not reach the continued threshold value, the processor determines whether the motion posture returns to the correct posture within a buffer time. In response to that the motion posture returns to the correct posture within the buffer time, the processor determines whether the continued time when the motion posture conforms to the correct posture reaches the continued threshold value. In response to that the motion posture does not return to the correct posture within the buffer time, the processor generates the notification message related to posture unfulfillment.

In an embodiment of the disclosure, in response to that the continued time does not reach the continued threshold value, the processor stops accumulating the continued time. In response to that the motion posture returns to the correct posture within the buffer time, the processor re-accumulates the continued time.

In an embodiment of the disclosure, in response to that the motion posture does not fulfill a minimum required posture, the processor generates the notification message related to posture unfulfillment. An angle corresponding to the minimum required posture is less than the angle corresponding to the correct posture.

In an embodiment of the disclosure, in response to that the motion posture does not conform to the correct posture within the stage time, the processor generates a notification message related to posture unfulfillment.

In an embodiment of the disclosure, the processor determines whether the motion posture conforms to the correct posture. In response to that the motion posture conforms to the correct posture, the processor determines whether the next motion gesture conforms to a second correct posture. In response to that the motion posture does not conform to the correct posture, the processor continues to confirm whether the next motion posture conforms to the correct posture.

In an embodiment of the disclosure, the motion evaluation system further includes a display. The display is coupled to the processor. The processor displays a simulated person on the display, and the processor controls a posture of the simulated person according to the sensing data so that the posture conforms to the motion posture.

From another perspective, the motion evaluation method in an embodiment of the disclosure includes the following steps. Sensing data is obtained, and the sensing data is provided for a motion posture. A continued time accumulated when the motion posture conforms to a correct posture is determined according to the sensing data, and the correct posture is related to an angle at which a portion under test inclined to a reference object. A notification message is sent according to the continued time.

In an embodiment of the disclosure, the step of determining the continued time accumulated when the motion posture conforms to the correct posture according to the sensing data includes the following steps. Whether the continued time when the motion posture conforms to the correct posture reaches a continued threshold value is determined. In response to that the continued time reaches the continued threshold value, a notification message related to posture fulfillment is generated.

In an embodiment of the disclosure, the step of determining the continued time accumulated when the motion posture conforms to the correct posture according to the sensing data includes the following steps. In response to that the continued time does not reach the continued threshold value, whether the motion posture returns to the correct posture within a buffer time is determined. In response to that the motion posture returns to the correct posture within the buffer time, whether the continued time when the motion posture conforms to the correct posture reaches the continued threshold value is determined. In response to that the motion posture does not return to the correct posture within the buffer time, the notification message related to posture unfulfillment is generated.

In an embodiment of the disclosure, the step of determining the continued time accumulated when the motion posture conforms to the correct posture according to the sensing data includes the following steps. In response to that the continued time does not reach the continued threshold value, accumulating the continued time is stopped. In response to that the motion posture returns to the correct posture within the buffer time, the continued time is re-timed.

In an embodiment of the disclosure, the step of determining whether the motion posture returns to the correct posture within the buffer time includes the following step. In response to that the motion posture does not fulfill a minimum required posture, the notification message related to posture unfulfillment is generated. An angle corresponding to the minimum required posture is less than the angle corresponding to the correct posture.

In an embodiment of the disclosure, the step of determining the continued time accumulated when the motion posture conforms to the correct posture according to the sensing data includes the following steps. In response to that the motion posture does not conform to the correct posture within the stage time, a notification message related to posture unfulfillment is generated.

In an embodiment of the disclosure, the step after the sensing data is obtained further includes the following steps. Whether the motion posture conforms to the correct posture is determined. In response to that the motion posture conforms to the correct posture, whether the next motion gesture conforms to a second correct posture is determined. In response to that the motion posture does not conform to the correct posture, whether the next motion posture conforms to the correct posture is continuously confirmed.

In an embodiment of the disclosure, the step after the sensing data is obtained further includes the following steps. A simulated person is displayed. A posture of the simulated person is controlled according to the sensing data so that the posture conforms to the motion posture.

The embodiments of the disclosure further provide a non-transitory computer-readable recording medium. The non-transitory computer-readable recording medium records a computer code for being loaded by a processor, and the processor may perform the foregoing method after loading the computer code.

To sum up, in the motion evaluation system, the method thereof, and the computer-readable recording medium provided by the embodiments of the disclosure, the sensor may determine the motion posture of a specific body portion of the person under test, so as to accordingly evaluate whether the sensed motion posture conforms to the predetermined correct posture as well as the continued time accumulated when the correct posture is maintained. Therefore, a doctor may assign a rehabilitation course, and the user may make practices and check whether his/her posture is correct according to the treatment content any time by himself/herself.

To make the aforementioned more comprehensible, several embodiments accompanied with drawings are described in detail as follows.

### BRIEF DESCRIPTION OF THE DRAWINGS

FIG. 1 is a block diagram of elements of a motion evaluation system according to an embodiment of the disclosure.

FIG. 2 is a flow chart of a motion evaluation method according to an embodiment of the disclosure.

FIG. 3 is a flow chart of a posture determination method according to an embodiment of the disclosure.

FIG. 4A to FIG. 4H are schematic diagrams illustrating a user interface according to an example.

### DESCRIPTION OF THE EMBODIMENTS

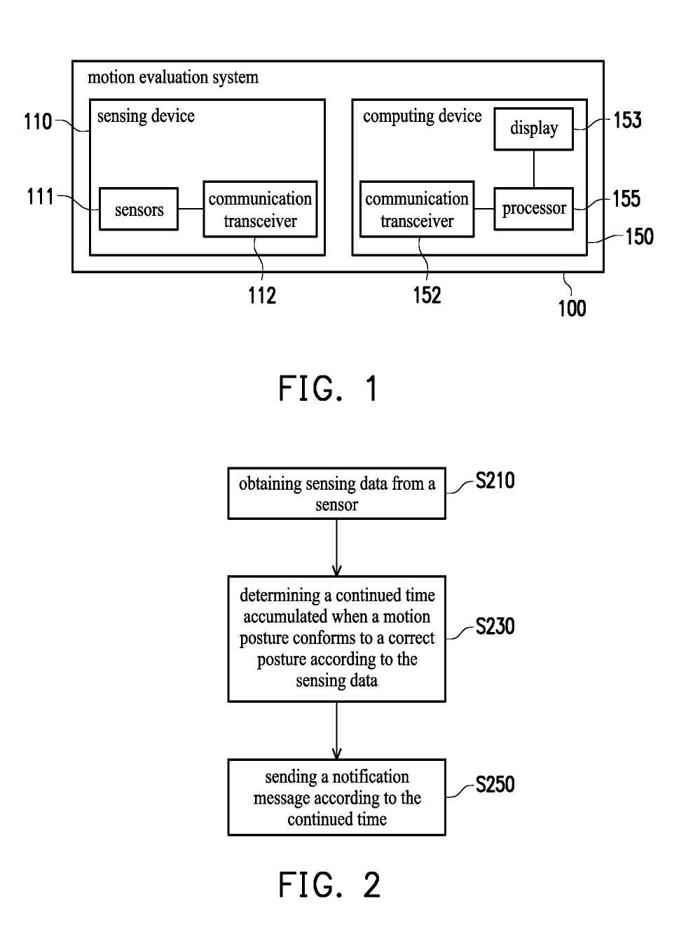

FIG. 1 is a block diagram of elements of a motion evaluation system 100 according to an embodiment of the disclosure. The motion evaluation system 100 includes but is not limited to one or more sensing devices 110 and a computing device 150.

The sensing device 110 includes but is not limited to one or more sensors 111 and a communication transceiver 112.

Each of the sensors 111 may be an accelerometer, a G-sensor, a gyroscope, a magnetometer, an inertial sensor, a laser sensor, an infrared ray (IR) sensor, an image sensor, or any combination of the foregoing sensors and is configured to sense sensing data such as acceleration, angular velocity, magnetic force, and/or images.

The communication transceiver 112 is coupled to the sensors 111. The communication transceiver 112 may be a wireless signal transceiver supporting wireless communication technologies such as Bluetooth, Wi-Fi, and infrared ray (IR) or a wired transmission interface such as the universal serial bus (USB), Thunderbolt, and universal asynchronous receiver/transmitter (UART) and is configured to send the sensing data of the sensor 111 to the outside (i.e., an external device, such as the computing device 150).

Note that in an embodiment, the sensing devices 110 may be wearable devices that are worn on a user's upper body, lower body, limbs, or other body portions. A main body of the sensing devices 110 may also be in the form of an upper garment, pair of pants, jacket, or the like. Alternatively, the sensing devices 110 can be attached to an elastic band, a belt, or the like for the body portion to wear. After the user puts on the sensing devices 110, the sensors 111 in the sensing devices 110 correspond to the user's body portions such as the forearms, upper arms, spine, thighs, shanks, etc. and may correspond to joints of the limbs, neck, and/or back.

The computing device 150 includes but is not limited to the communication transceiver 152, the display 153, and the processor 155. The computing device 150 may be a cell phone, a tablet computer, a notebook computer, or any computer system.

Implementation and functions of the communication transceiver 152 may be obtained with reference to the description of the communication transceiver 112 as described above, and repeated description is thus not provided herein.

The display 153 may be a liquid-crystal display (LCD), a light-emitting diode (LED) display, an organic light-emitting diode (OLED) display, or a display of other types.

The processor 155 is coupled to the communication transceiver 152 and the display 153. The processor 155 may be a central processing unit (CPU) or other programmable microprocessor for general or special use, a digital signal processor (DSP), a programmable controller, an application-specific integrated circuit (ASIC), or any other similar devices or a combination of the foregoing devices. In the embodiments of the disclosure, the processor 155 is configured to performs all operations of the computing device 150 and may load and execute software programs/modules, files, and data of a variety of types.

In order to better understand the operation flow of the embodiments of the disclosure, numerous embodiments are listed to describe the operation of the motion evaluation system 100 in the embodiments of the disclosure in detail. In the following paragraphs, reference will be made to the elements and modules of the sensing device 110 and the computing device 150 for describing the method provided by the embodiments of the disclosure. The steps of the method may be adjusted according to actual implementation and are not limited by the disclosure.

FIG. 2 is a flow chart of a motion evaluation method according to an embodiment of the disclosure. With reference to FIG. 2, the sensor 111 generates sensing data of a motion posture of a portion under test (e.g., a specific body portion of a person under test) at which the sensor 111 is disposed. According to implementation of the sensor 111, the sensing data may be raw data such as acceleration, angular velocity, and/or magnetic force, orientation in three axial directions, and sensing images. The sensing data is sent to the computing device 150 through the communication transceiver 112. The processor 155 may thereby receive the sensing data from the sensor 111 in the sensing device 110 through the communication transceiver 152 (step S210).

Note that before the processor 155 obtains the sensing data, the computing device 150 may be paired with and connected to the sensing device 110. According to the protocols supported by the communication transceivers 112 and 152, connection between the two devices 110 and 150 may be established. In some application scenarios, several groups of sensing devices 110 may be provided, and the computing device 150 pairs each of the sensing devices 110 with portions under test (e.g., arms, neck, knees, etc.) of the person under test one by one by means of code recognition (e.g., QR codes, two-dimensional barcodes, etc.), switch triggering (e.g., triggering a button, a switch, and etc.), and the like. For instance, a unique QR code is printed on an outer surface of a main body of the sensing device 110, and in response to selection of arm parts made by the user through a user interface of the display 153, the computing device 150 provides an image capturing device (e.g., a camera, a video camera, etc.) with the QR code on the sensing device 110 for scanning, so that the sensing device 110 is paired with a specific portion under test. In another example, a button is provided on the main body of the sensing device 110. In response to selection of the right knee made by the user through the user interface on the display 153, the sensing device 110 detects whether the button thereof is pressed within five seconds. If the button is pressed, the sensing device 110 is paired with the right knee part. The portion under test and the sensor 111 may be paired through many other implementation manners, which is not limited by the disclosure.

In addition, after pairing is completed, the computing device 150 further provides a calibration process. In an embodiment, the processor 155 displays a simulated person and a calibration posture on the display 153. The calibration posture is, for example, moving the portion under test to a specific position which can be referenced to by the person under test to be accordingly executed. After the sensing data of the sensor 111 is obtained, the processor 155 may convert the sensing data into parameters of the motion posture (e.g., an angle at which the portion under test inclined to a reference object (e.g., the body, an imaginary axis) and the position, orientation, quaternion, Euler angle, rotation vector in space, etc.) according to manners such as table lookup and function conversion and accordingly associates the sensing data with the motion posture. Next, the processor 155 may control a posture of the simulated person to be matched with the motion posture of the person under test according to the sensing data. For instance, when the person under test raises his/her right hand, the simulated person follows and raises his/her right hand as well.

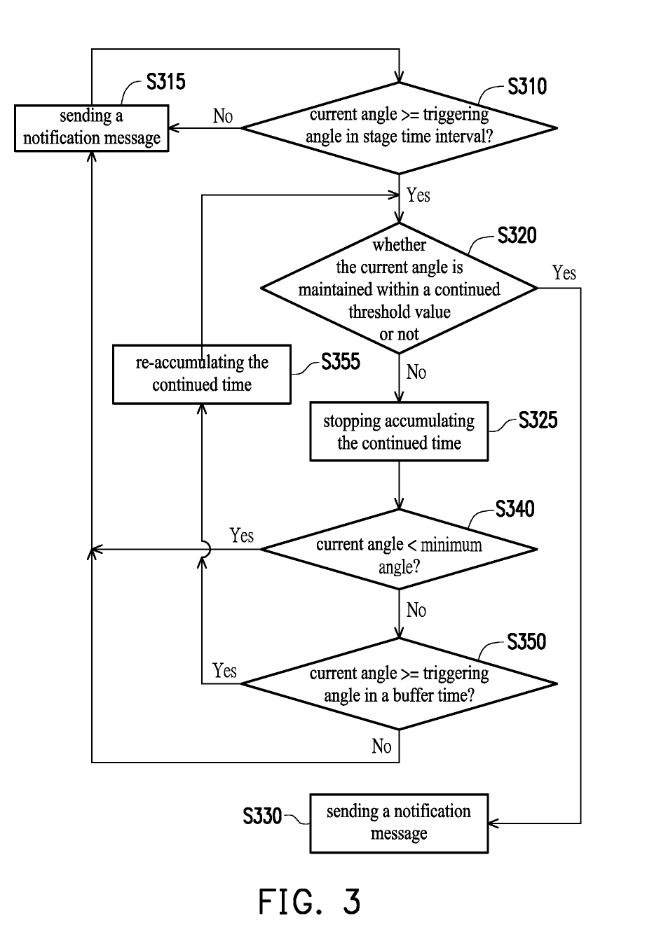

Next, the processor 155 determines a continued time accumulated when the motion posture of the person under test conforms to a correct posture according to the sensing data (step S230) and sends a notification message according to the continued time (step S250). To be specific, FIG. 3 is a flow chart of a posture determination method according to an embodiment of the disclosure. With reference to FIG. 3, the correct posture is a posture and/or a motion combination by a doctor or professional for a rehabilitation treatment. For instance, the correct posture may be raising the right hand to 90 degrees, lifting the left foot, squatting down etc. The computing device 150 may obtains data related to the correct posture of the rehabilitation treatment through data download from the Internet or data input from a flash drive.

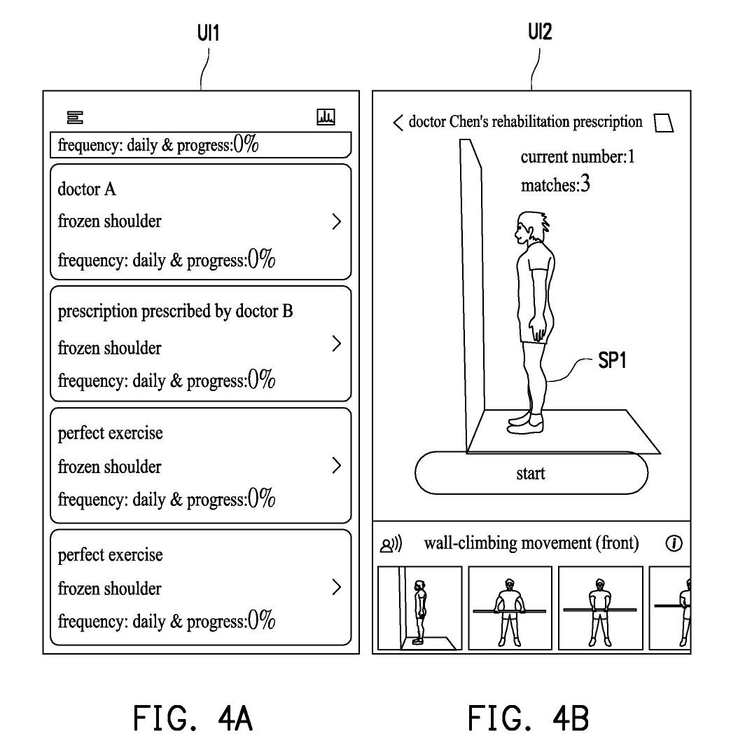

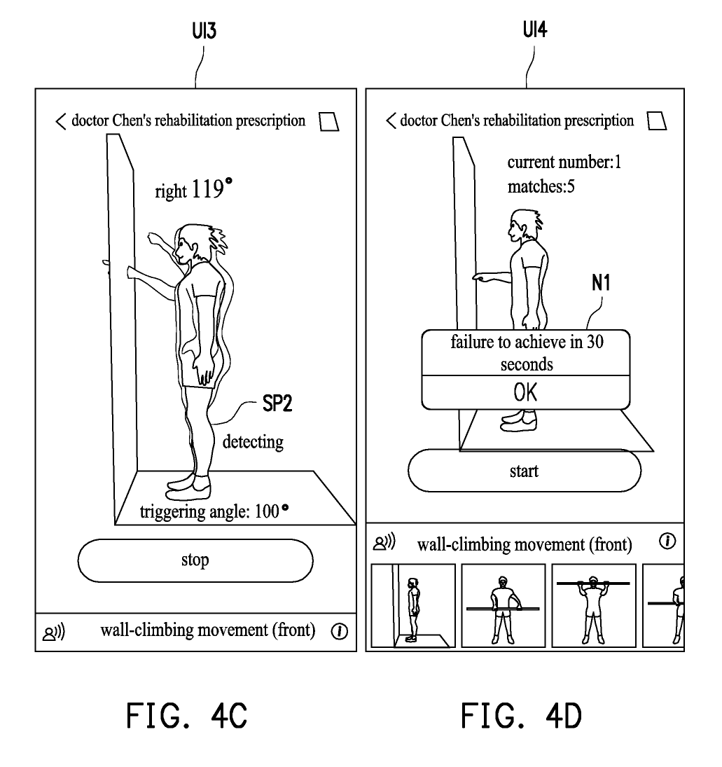

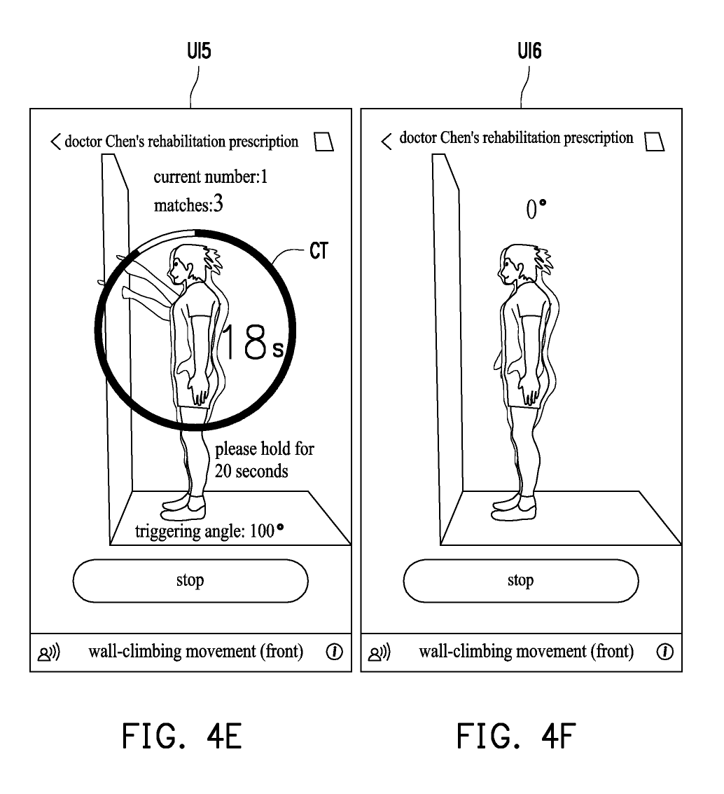

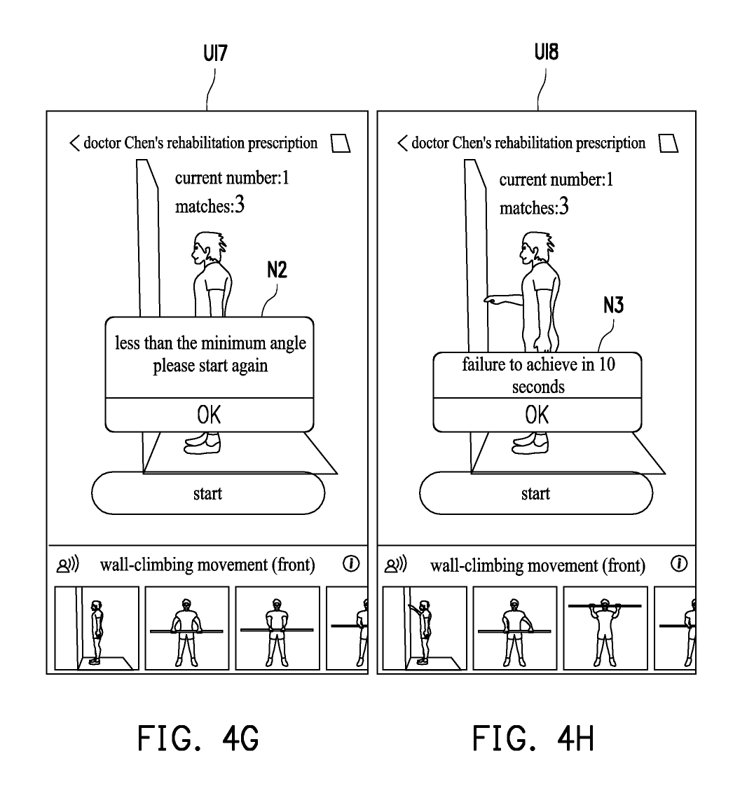

FIG. 4A to FIG. 4H are schematic diagrams illustrating a user interface according to an example. The description of the user interface provided as follows is provided with reference to FIG. 3 and FIG. 4A to FIG. 4H together. With reference to FIG. 4A first, the processor 155 displays a user interface UI1 on the display 153. The user interface UI1 may record rehabilitation treatments established by different people and corresponding completion progresses and execution frequency thereof. The user may select the rehabilitation treatment to be performed by himself/herself. With reference to FIG. 4B, it is assumed that one rehabilitation treatment is selected by the user, a user interface UI2 displayed by the display 153 may then present a simulated person SP1, and the simulated person SP1 changes its postures along with sensing data of the sensor 111. The user interface UI2 may also provide content of all postures to be performed in the treatment for the user's reference in advance. In addition, the user interface UI2 may provide content related to a current execution number of a correct posture and a number of the motion postures conforming to the correct posture.

After the rehabilitation treatment is started, the processor 155 may obtain the current motion posture of the person under test through analyzing the sensing data and compares parameters of the motion posture with that of the correct posture to obtain differences therebetween. For instance, whether an angle is greater than an angle corresponding to the correct posture or whether an angle difference is less than a predetermined range is obtained. In this embodiment, in response to the start of the rehabilitation treatment, the processor 155 determines whether an angle of the current motion posture is greater than or equal to a triggering angle in a stage time (step S310). The triggering angle is the angle corresponding to the correct posture (relative to a specific reference object (reference axis)). For instance, the triggering angle may correspond to an angle of rotation of an imaginary Z axis. The stage time may be 10 seconds, 30 seconds, or one minute and so on. That is, the angle corresponding to the correct posture is used to determine whether the motion posture conforms to the correct posture in this embodiment. Taking FIG. 4C for example, a user interface UI3 may present the triggering angle (100 degrees) and the angle of the motion posture (119 degrees), and a simulated person SP2 raises the right hand.

In response to that the motion posture does not conform to the correct posture within the stage time, the processor 155 generates a notification message related to posture unfulfillment (step S315). The notification message may be sent out through an image or a voice. Taking FIG. 4D for example, a user interface UI4 presented by the display 153 includes a notification message N1, and the notification message N1 provides negative content for the user to understand the situation. Alternatively, a speaker may be additionally connected to the computing device 150, and the speaker may be used to play a voice message saying that the motion posture does not conform to the correct posture. Next, the processor 155 may re-determine whether the angle of the current motion posture is greater than or equal to the triggering angle in the stage time (step S310 is performed again).

Note that the text or picture in the notification message or the voice content may be adjusted according to actual needs, which is not limited by the embodiments of the disclosure. In addition, in other embodiments, the processor 155 may also omit setting the stage time.

From another perspective, in response to that the motion posture conforms to the correct posture in the stage time, the processor 155 may determine whether the motion posture is maintained in the correct posture within a continued threshold value (step S320) and accumulates the continued time when the motion posture conforms to the correct posture. The continued threshold value may be 20 seconds, 40 seconds, or one minute and so on. In addition, through determining whether the angle corresponding to the motion posture continues to be greater than or equal to the triggering angle, the processor 155 may determine that whether the motion posture continues to maintain in the correct posture. As long as the angle corresponding to the motion posture is still greater than or equal to the triggering angle, the processor 155 continues to accumulate the continued time. Taking FIG. 4E for example, before the continued threshold value of 20 seconds is reached, a user interface UI5 presented by the display 153 includes continued time information CT (e.g., lasting for 18 seconds) being currently timed.

Next, in response to that the continued time reaches the continued threshold value, the processor 155 may generate the notification message related to gesture fulfillment (step S330). For instance, the display 153 displays the content of “the 5th posture is completed, please continue to the next posture”. If the rehabilitation treatment is not finished, the processor 155 evaluates whether an angle of the next motion posture is greater than or equal to the triggering angle in the stage time (step S310 is performed again).

From another perspective, in response to that the continued time does not reach the continued threshold value, the processor 155 may stop accumulating the continued time and determines whether the angle corresponding to the motion posture is less than an angle of a minimum required posture in a buffer time (step S340). The angle corresponding to the minimum required posture is less than the angle corresponding to the correct posture. For instance, the triggering angle is 90 degrees, and the angle corresponding to the minimum required posture may be 60 degrees. The buffer time may be 2 seconds, 5 seconds, or 10 seconds. In response to that the motion posture does not achieve the minimum required posture (e.g., the angle of the motion posture is less than a minimum angle), the processor 155 generates a notification message related to posture unfulfillment (step S315) and re-evaluates the current correct posture (step S310 is performed again).

Taking FIG. 4F for example, it is assumed that the minimum angle corresponding to the minimum required posture is 40 degrees, and a current angle of the person under test presented by a user interface UI6 presented by the display 153 is 0 degrees (less than 40 degrees). With reference to FIG. 4G next, a user interface UI7 presented by the display 153 includes a notification message N2, and the notification message N2 provides negative content for the user to understand the situation of not conforming to the minimum required posture.

In addition, in the buffer time, in response to that the motion posture achieves the minimum required posture (e.g., the angle of the motion posture is greater than the minimum angle), the processor 155 may further determine whether the motion posture returns to the correct posture (step S350). In this embodiment, the processor 155 determines that whether the angle of the current motion posture is greater than or equal to the triggering angle again. In response to that the motion posture returns to the correct posture within the buffer time, the processor 155 re-accumulates the continued time (step S355) and determines that whether the continued time accumulated when the motion posture conforms to the correct time reaches the continued threshold value (step S320 is performed again). That is, as long as the motion posture reaches the correct posture again within the buffer time, whether the posture is maintained in the correct posture is re-evaluated. From another perspective, in response to that the motion posture does not return to the correct posture within the buffer time, the processor 155 generates a notification message related to posture unfulfillment (step S315). Taking FIG. 4H for example, a user interface UI8 presented by the display 153 includes a notification message N3, and the notification message N3 provides negative content for the user to understand the situation of not returning to the correct posture.

It thus can be seen that the present embodiment provides baselines of the triggering angle, stage time, continued threshold value, and the minimum angle to be used to determine whether the motion posture of the person under test is incorrect so that the rehabilitation treatment needs to be interrupted. In this way, monitoring is achieved and the person under test is not to intentionally ignore the posture and try to relax. Note that in other embodiments, the process flow of FIG. 3 may be adjusted. For instance, step S355 is the time of stopping accumulating when step S325 is performed again, step S340 and step S350 may be simultaneously performed, and step S310 is to be re-started as long as the posture in step S320 cannot be maintained. Besides, the angle between the motion posture and the reference object is compared with the correct posture in the embodiment of FIG. 3, and in other embodiments, comparisons may also be made through parameters such as quantized values of an accelerometer on the three axes, spatial positions, etc.

In addition to the evaluation of a single correct posture, multiple identical or different postures may also be included in the rehabilitation treatment. In an embodiment, the processor 155 determines whether the motion posture conforms to the correct posture. For instance, the processor 155 determines whether the angle reaches the triggering angle. In response to that the motion posture conforms to the correct posture, the processor 155 continues to determine whether a next motion posture conforms to a next correct posture, and the processor 155 does not stop making determination until all correct postures in the treatment are achieved. Depending on the content of the treatment, the two previous and the next postures may be identical or may be different. From another perspective, in response to that the motion posture dose not conform to the correct posture, the processor 155 continues to confirm that whether the next motion posture conforms to the current correct posture. That is, as long as the motion posture has not been able to achieve the correct posture of this time, evaluation of the next following correct posture cannot be performed.

For instance, the rehabilitation treatment may require postures of deep squats to be performed for three times. The processor 155 determines whether the motion posture of the thigh of the person under test reaches a triggering angle of 90 degrees. As long as the triggering angle is achieved, the processor 155 determines whether the next motion posture performing the deep squat achieves the 90-degree triggering angle. In contrast, the processor 155 continues to determine whether the first deep squat motion is completed.

Note that the processor 155 may further analyze the evaluation of the motion posture, so as to obtain information such as the number of completions, number of failures, frequency of execution, and content of rehabilitation. The information may be recorded for the user himself/herself to know or for a doctor to evaluate the rehabilitation progress.

From another perspective, the disclosure further provides a non-transitory computer-readable recording medium configured to record a computer code to be loaded into the processor 155 disposed in the computing device 150. The computer code consists of multiple program instructions (e.g., an organization chart, a program establishment instruction, a table approval program instruction, a setup program instruction, and a program building up instruction). Once the program instruction is loaded to and executed by the computing device 150, the foregoing motion evaluation method may thereby be completed.

In view of the foregoing, the motion evaluation system and the method thereof and the computer-readable recording medium provided by the embodiments of the disclosure may be used by doctors or professionals to create content of the rehabilitation treatment. Multiple execution postures are recorded in the treatment. In the embodiments of the disclosure, the sensor may determine the motion posture of the person under test, so as to evaluate whether the motion posture conforms to the correct posture recorded by the rehabilitation treatment as well as the continued time when the correct posture is maintained. Accordingly, the user may make practices and check whether his/her posture is correct according to the treatment content any time by himself/herself. In addition, multiple baselines for error or interruption determination are also provided by the embodiments of the disclosure, so as to urge the user to complete all courses of the treatment.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A motion evaluation system, comprising:
at least one sensor, configured to generate sensing data for a motion posture; and
a processor, configured to obtain the sensing data of the at least one sensor, determining a continued time accumulated when the motion posture conforms to a correct posture according to the sensing data, and sending a notification message according to the continued time, wherein the correct posture is related to an angle at which a portion under test inclined to a reference object.

2. The motion evaluation system as claimed in claim 1, wherein
the processor determines whether the continued time when the motion posture conforms to the correct posture reaches a continued threshold value, and
the processor generates the notification message related to posture fulfillment in response to that the continued time reaches the continued threshold value.

3. The motion evaluation system as claimed in claim 2, wherein
the processor determines whether the motion posture returns to the correct posture within a buffer time in response to that the continued time does not reach the continued threshold value,
the processor determines whether the continued time when the motion posture conforms to the correct posture reaches the continued threshold value in response to that the motion posture returns to the correct posture within the buffer time, and
the processor generates the notification message related to posture unfulfillment in response to that the motion posture does not return to the correct posture within the buffer time.

4. The motion evaluation system as claimed in claim 3, wherein
the processor stops accumulating the continued time in response to that the continued time does not reach the continued threshold value, and
the processor re-accumulates the continued time in response to that the motion posture returns to the correct posture within the buffer time.

5. The motion evaluation system as claimed in claim 3, wherein
the processor generates the notification message related to posture unfulfillment in response to that the motion posture does not fulfill a minimum required posture, wherein an angle corresponding to the minimum required posture is less than an angle corresponding to the correct posture.

6. The motion evaluation system as claimed in claim 1, wherein
the processor generates the notification message related to posture unfulfillment in response to that the motion posture does not conform to the correct posture within a stage time.

7. The motion evaluation system as claimed in claim 1, wherein
the processor determines whether the motion posture conforms to the correct posture,
the processor determines whether a next motion gesture conforms to a second correct posture in response to that the motion posture conforms to the correct posture, and
the processor continues to confirm whether the next motion posture conforms to the correct posture in response to that the motion posture does not conform to the correct posture.

8. The motion evaluation system as claimed in claim 1, further comprising:
a display, coupled to the processor, wherein the processor displays a simulated person on the display, and the processor controls a posture of the simulated person according to the sensing data, so that the posture conforms to the motion posture.

9. A motion evaluation method, comprising:
obtaining sensing data, wherein the sensing data is provided for a motion posture;
determining a continued time accumulated when the motion posture conforms to a correct posture according to the sensing data, wherein the correct posture is related to an angle at which a portion under test inclined to a reference object; and
sending a notification message according to the continued time.

10. The motion evaluation method as claimed in claim 9, wherein the step of determining the continued time accumulated when the motion posture conforms to the correct posture according to the sensing data comprises:
determining whether the continued time when the motion posture conforms to the correct posture reaches a continued threshold value, and
generating the notification message related to posture fulfillment in response to that the continued time reaches the continued threshold value.

11. The motion evaluation method as claimed in claim 10, wherein the step of determining the continued time accumulated when the motion posture conforms to the correct posture according to the sensing data comprises:
determining whether the motion posture returns to the correct posture within a buffer time in response to that the continued time does not reach the continued threshold value;
determining whether the continued time when the motion posture conforms to the correct posture reaches the continued threshold value in response to that the motion posture returns to the correct posture within the buffer time; and
generating the notification message related to posture unfulfillment in response to that the motion posture does not return to the correct posture within the buffer time.

12. The motion evaluation method as claimed in claim 11, wherein the step of determining the continued time accumulated when the motion posture conforms to the correct posture according to the sensing data comprises:
stopping accumulating the continued time in response to that the continued time does not reach the continued threshold value; and
re-accumulating the continued time in response to that the motion posture returns to the correct posture within the buffer time.

13. The motion evaluation method as claimed in claim 11, wherein the step of determining whether the motion posture returns to the correct posture within the buffer time comprises:
generating the notification message related to posture unfulfillment in response to that the motion posture does not fulfill a minimum required posture, wherein an angle corresponding to the minimum required posture is less than an angle corresponding to the correct posture.

14. The motion evaluation method as claimed in claim 9, wherein the step of determining the continued time accumulated when the motion posture conforms to the correct posture according to the sensing data comprises:
generating the notification message related to posture unfulfillment in response to that the motion posture does not conform to the correct posture within a stage time.

15. The motion evaluation method as claimed in claim 9, wherein the step after the sensing data is obtained further comprises:
determining whether the motion posture conforms to the correct posture;
determining whether a next motion gesture conforms to a second correct posture in response to that the motion posture conforms to the correct posture; and
continuously confirming whether the next motion posture conforms to the correct posture in response to that the motion posture does not conform to the correct posture.

16. The motion evaluation method as claimed in claim 9, wherein the step after the sensing data is obtained further comprises:
displaying a simulated person; and
controlling a posture of the simulated person according to the sensing data, so that the posture conforms to the motion posture.

17. A non-transitory computer-readable recording medium, recording a computer code, loading and performing the following steps through a processor:
obtaining sensing data, wherein the sensing data is provided for a motion posture;
determining a continued time accumulated when the motion posture conforms to a correct posture according to the sensing data, wherein the correct posture is related to an angle at which a portion under test inclined to a reference object; and
sending a notification message according to the continued time.
